(19) United States
(12) Patent Application Publication
(10) Pub. No.: US 2015/0074218 A1
(43) Pub. Date: Mar. 12, 2015

(54) CLOUD ENTERPRISE APPLICATION SYSTEM.

(71) Applicant: Chi-Dau Shih, Taipei (TW)

(72) Inventor: Chi-Dau Shih, Taipei (TW)

(21) Appl. No.: 14/020,906

(22) Filed: Sep. 9, 2013

(51) Int. Cl. H04L 29/08

(52) U.S. Cl. CPC H04L 67/2842
USPC 709/213

(57) ABSTRACT

A cloud enterprise application system is directly constructed in the cloud without installing to the individual use's computer devices. As the edition of the application is modified, and it is only needed to change the edition in the cloud structure. One enterprise has a dedicated database (sub-directory). All data generated by various application units are automatically stored in the dedicated sub-directory instead of the operation environments of the users. For one enterprise, all the application units performed by the enterprise are directed to the sub-directory of the enterprise. They directly access the data of the sub-directory specific to the enterprise. Thus the compatibility of the data between different application is high. The data files are not distributed in many different computers so that problems induced from data management are greatly reduced. Furthermore, the object of this system is to enterprises instead of individual users.

### FIELD OF INVENTION

The present invention relates to cloud applications, and in particular to a cloud enterprise application system.

### BACKGROUND OF THE INVENTION

In the prior arts, there are many application software for enterprises, while these application software have following disadvantages, such as all the software are independent to each other. The data formats for generating files are only suitable for itself. The files not properly converted or without the operations from users are not suitable for other software. That is, the data files are not completely compatible to each other.

Besides, data files from one kind of software are distributed in different storages areas based on the user's operation environment. For example, files from Microsoft word are stored on different computers based on the users using the ‘word’. If for one enterprise, there are 100 people using the ‘word’. All the ‘word’ files generated by the Microsoft word are stored in the individual computers based on the user that generates the files. But in some usages, it is needed that all files are concentrated in one place for easily accessing and management. The current structure causes that the files are distributed disorderly.

Furthermore, the prior art applications are not used in cloud structure so that the individual user must install the software in their computers. If the edition of the application is modified, all the applications in different computers must be re-installed one by one. This is very inconvenient and even many computers do not update for new edition so as to induce some inconveniences in working.

However, currently, cloud structure is widely used in many applications, while most of current used enterprise application units have no well forms for cloud structure so that the advantages of using cloud structure are not fully developed. As a result, the applications do not provide best profits to the enterprises using them.

### SUMMARY OF THE INVENTION

To resolve above object, the present invention provides a cloud enterprise application system, in that the present invention adapts a cloud structure. All the application units are directly constructed in the cloud without installing to the individual use's computer devices. As the edition of the application is modified, it is only needed to change the edition in the cloud structure without needing to change all editions in individual computers of users. Therefore, installing and updating works are easy and convenient. Furthermore, one enterprise has a dedicated database (sub-directory). All data generated by various application units are automatically stored in the dedicated sub-directory instead of the operation environments of the users. For one enterprise, all the application units performed by the enterprise are directed to the sub-directory of the enterprise. They directly accesses the data of the sub-directory specific to the enterprise. Thus the compatibility of the data between different application units is high. The data files are not distributed in many different computers so that problems induced from data management are greatly reduced. Furthermore, the object of this system is to enterprises instead of individual users, which is convenient to enterprises.

### BRIEF DESCRIPTION OF THE DRAWINGS

FIG. 1 is a block diagram about the hardware structure of the present invention.

FIG. 2 shows the relation between the hardware structure and software system of the present invention.

FIG. 3 is a block diagram showing the could enterprise application system of the present invention and the peripherals thereof.

FIG. 4 is a block diagram about the system management unit of the present invention.

FIG. 5 shows another form about the could enterprise application system of the present invention and the peripherals thereof.

### DETAILED DESCRIPTION OF THE PREFERRED EMBODIMENTS

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

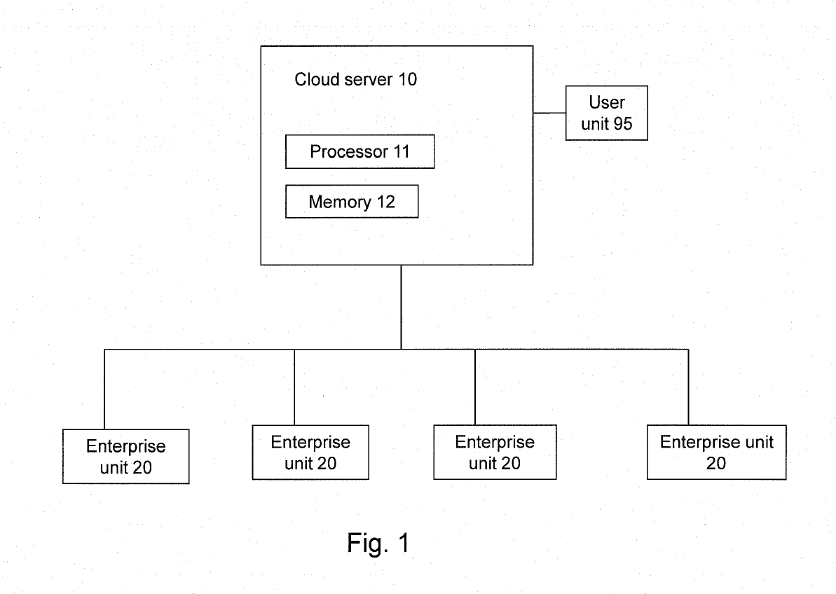

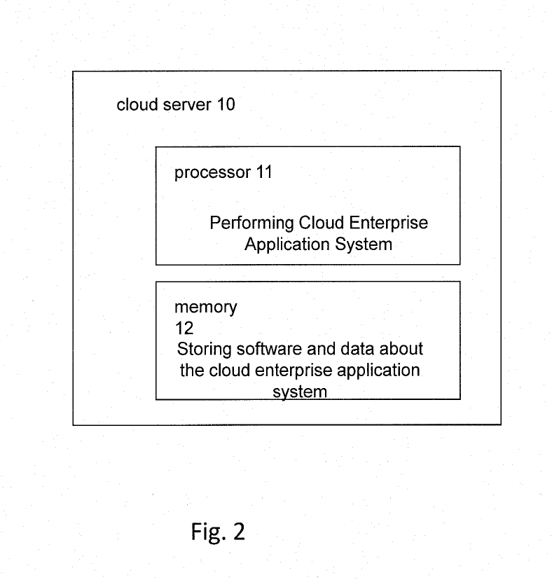

With reference to FIGS. 1 and 2, the structure of the present invention is illustrated. The present invention includes the following elements.

With reference to FIG. 1, the present invention mainly has a cloud server 10. The cloud enterprise application system 1 of the present invention is installed in the cloud server 10. The system is operated by the cloud server 10. The cloud server 10 is connected to at least one enterprise unit 20. An enterprise enters into the cloud server 10 through the enterprise unit 20 so as to connect to the system of the present invention. Besides, the cloud server 10 is connected with at least one user unit 95. A user can connect the user unit 95 firstly and then connect to the system of the present invention. The enterprise unit 20 and user unit 95 may be selected from a group containing computers, notebook computers, Ipads, handsets, PDAs, etc.

The cloud server 10 includes a processor 11 and a memory 12. The processor 11 serves to perform the operations of the present invention. The memory 12 serves to store the data and operation programs of the present invention, related operation results and data.

The cloud enterprise application system 1 of the present invention is installed in the cloud server 10. The software and data of the system is stored in the memory 12. The operation related to the system is performed by the processor 11. The cloud server 10 may be realized by various electronic computer devices including computers, handsets, Ipads, notebook computers, PDAs, etc. The cloud server 10 is contrasted in these electronic computer devices.

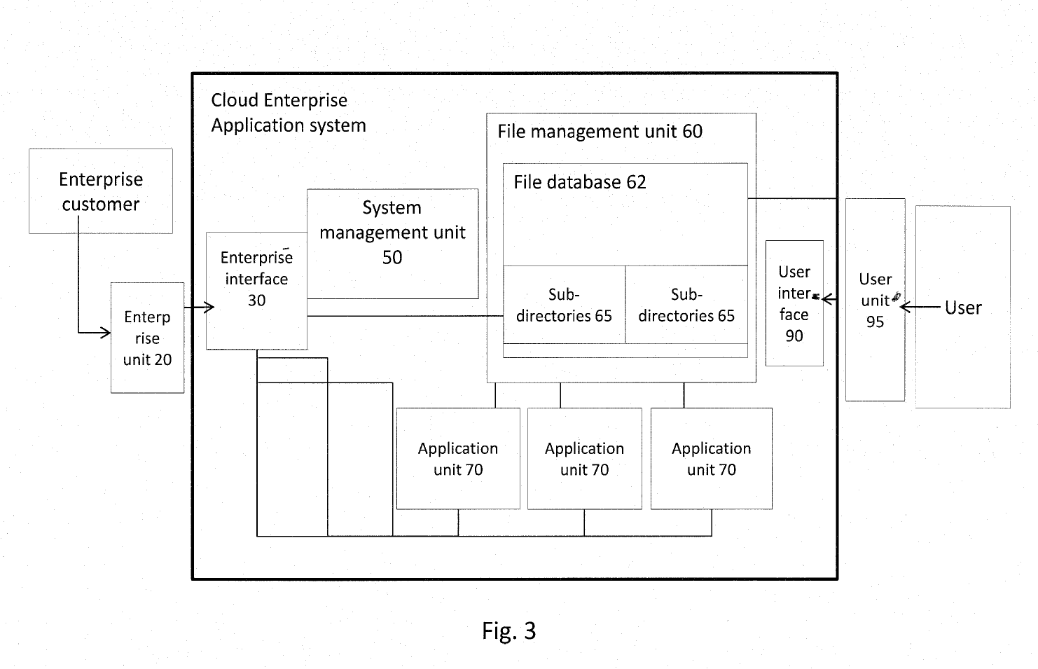

In the present invention, the cloud server 10 includes the following elements with reference to FIG. 3.

An enterprise interface 30 serves to receive data from enterprise customers. The enterprise customers may be connected to the enterprise interface 30 of the present invention through the enterprise unit 20. Then the enterprise customers enter into the system of the present invention through the enterprise interface 30 for using the functions provided by the present invention.

As the enterprise customer firstly users the system of the present invention, he (or she) should register into the system of the present invention firstly. Then the system platform will download an APP to the enterprise unit 20. By the APP, the enterprise customer could connect to the system of the present invention. The enterprise customer may be realized by various electronic computer devices including computers, handsets, Ipads, notebook computers, PDAs, etc.

A user interface 90 serves to interface a user to the system of the present invention. The user connects to the user interface 90 through the user unit 95 (realized by various electronic computer devices including computers, handsets, Ipads, notebook computers, PDAs, etc.). The user could enter into the system through the user interface 90 so as to use various services provided by the system of the present invention.

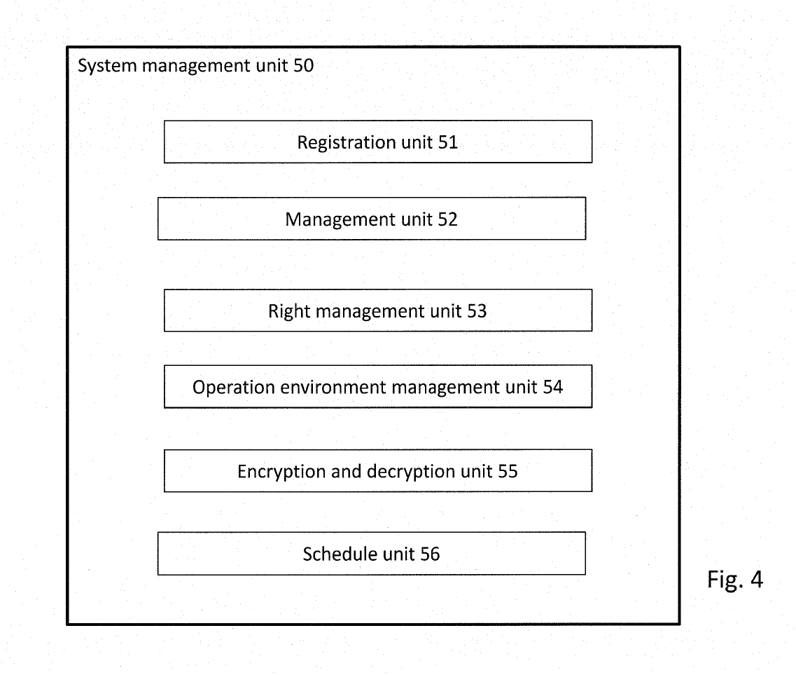

A system management unit 50 serves for performing related operations about management of the system. As illustrated in FIG. 4, the system management unit 50 include a registration unit 51 for registration of the enterprises connected to the system of the present invention; an APP management unit 52 for transferring an APP to the enterprise unit 20 through the enterprise interface 30 so that the enterprise customers connects to the system of the present invention; the system management unit 50 also includes a right management unit 53 for determining the rights of the enterprise customers for using the services provided by the present invention.

The system management unit 50 also includes an operation environment management unit 54 for management of the operation environment so that the operation environment of an enterprise or a user can be stored in the cloud server 10. As the enterprise customer or the user changes positions to use another enterprise unit 20 or another user unit 95, he (or she) can work in the previous stored operation environment without interruption. Furthermore, the system management unit 50 further includes a schedule unit 56 which can schedule a series works to be done based on a preset work sequence. For example, an account table can be transferred to the accountant manger after it is complete by an accountant. Or, when a repairing work is done, a repairing table and invoice will be provided to the customer for checking the repairing work and payment of fees. Furthermore, the file management in operation is performed by the schedule unit so that a file will not be called by a plurality of user at a time. That is, at a time, only one file is used by a specific user to avoid that the file is modified by several users at a time.

A file management unit 60 serves to manage all the data files used and generated in the system of the present invention. The main feature of this unit is that all the data files generated by the system are stored in one database. The file management unit 60 includes a single one file database 62. The file database 62 includes a plurality of sub-directories 65. Each sub-directory 65 is assigned to a single enterprise. All the data of the enterprise even from different application software is stored in the sub-directory 65 thereof. Thus, the feature of the present invention is that all the data storage of one enterprise are stored in one dedicated sub-directory 65 automatically. This is helpful for data management.

At least one application unit 70 serves to provide some application through the system of the present invention. All the data of the application unit 70 is directed to the file database 62. An enterprise customer can use the application unit 70 through the enterprise interface 30 for performing the application and then the data generated in this application is stored in the sub-directory 65 in the file database 62. Furthermore, in performing the application, the application will automatically direct to the sub-directory 65 assigned to the enterprise so that all the data needed in the application is called out from the sub-directory 65.

One main feature of the present invention is that the system may have a plurality of application units 70 and all the application units 70 are directed to the file database 62. The data generated by the application unit 70 is directed to the sub-directory 65 in the file database 62 specific to the enterprise customer using the application. Moreover, from one enterprise unit 20, there is only one password which is acceptable by all the application units 70.

In the prior art application, the location for storing a file generated by one application is based on the operation environment of the user. Various applications are not compatible in passwords and storage locations. But in the present invention, the files generated by one enterprise are automatically stored to the sub-directory 65 assigned to the enterprise instead of the operation environment of the enterprise customers. All the files and passwords are compatible for various applications.

In the present invention, a user can connect to the system of the present invention through the user interface 90 and then enter into the sub-directory 65 opened for the user so as to read data in the sub-directory 65. Since in the present invention, a cloud structure is claimed, all users in any location can access the data by connecting to the cloud structure without limitation of the locations.

Furthermore, since a cloud structure is used in the present invention, the operation environment of a user can be stored in the cloud structure. When the location of the user is changed, the user can directly access to the cloud structure for calling the operation environment previously stored in the cloud structure by using another computer devices. Thus the work are not interrupted due to the change of location. Therefore, the work done in duty can be done after going home without interruption.

Referring to FIG. 4 it is illustrated that the system management unit 50 further includes an encryption and decryption unit 55 for encrypting and decrypting the data in the sub-directory 65 so as to keep safe to the data.

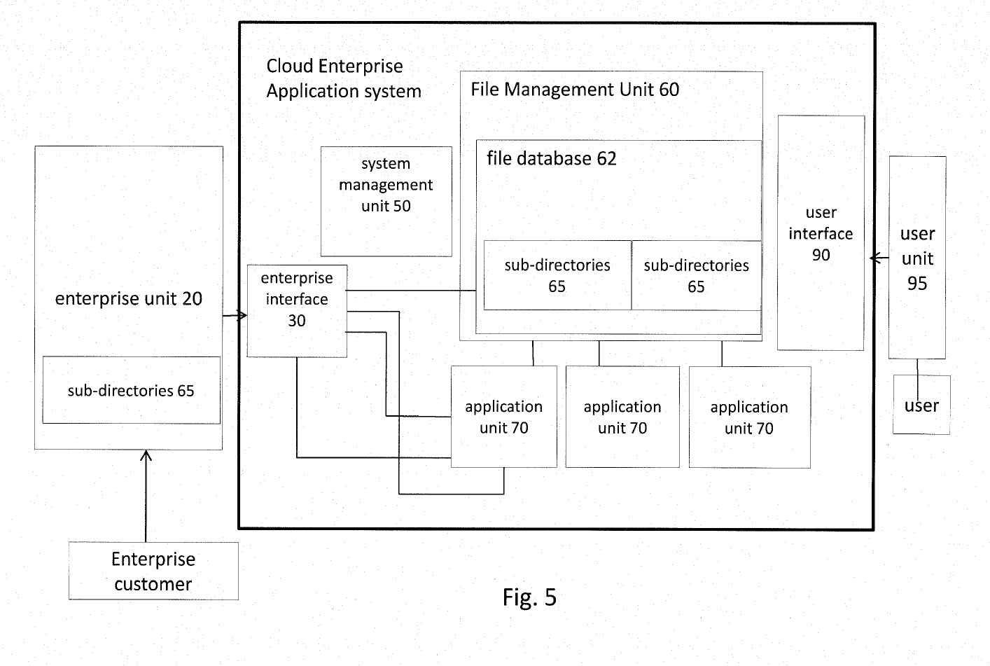

With reference to FIG. 5, in one embodiment of the present invention, the sub-directory 65 of the file database 62 may be located directly in the enterprise unit 20. This is based on the selection of the enterprise customer.

Advantages of the present invention are that: the present invention adapts a cloud structure. All the application units are directly constructed in the cloud without installing to the individual use's computer devices. As the edition of the application is modified, it is only needed to change the edition in the cloud structure without needing to change all editions in individual computers of users. Therefore, installing and updating works are easy and convenient. Furthermore, one enterprise has a dedicated database (sub-directory 65). All data generated by various application units 70 are automatically stored in the dedicated sub-directory 65 instead of the operation environments of the users. For one enterprise, all the application units 70 performed by the enterprise is directed to the sub-directory of the enterprise. They directly access the data of the sub-directory specific to the enterprise. Thus compatibility of the data between different application units 70 is high. The data files are not distributed in various computers so that problems of data management are not induced. Furthermore, the object of this system is to enterprises instead of individual users, which is convenient to enterprises.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A cloud enterprise application system, comprising:
a cloud server installed with a cloud enterprise application system for developing applications of the cloud enterprise application system;
the cloud server being connected to at least one enterprise unit; an enterprise can entering into the cloud server through the enterprise unit so as to enter into the cloud enterprise application system;
the cloud server including a processor and a memory;
software and data of the cloud enterprise application system being stored in the memory; the processor performing related operations of the system;
the cloud enterprise application system including:
an enterprise interface for receiving data from enterprise customers; the enterprise customers connected to the enterprise interface through the enterprise unit; then the enterprise customers entering into the system through the enterprise interface for using functions provided by the system;
a system management unit for performing related operations about management of the system; the system management unit including a registration unit for registration of the enterprises; an APP management unit for transferring an APP to the enterprise unit through the enterprise interface so that the enterprise customers connects to the system; and
a file management unit for managing all the data files used and generated in the system; the main feature of this unit being that all the data files generated by the system are stored in one database; the file management unit including a single one file database; the file database including a plurality of sub-directories; each sub-directory being assigned to a single enterprise; all the data of the enterprise even from different application software is stored in the sub-directory thereof and thus, all the data storage of one enterprise being stored in one dedicated sub-directory automatically; and
at least one application unit for providing applications to enterprises; all the data of the application unit being directed to the file database; an enterprise customer can use the application unit through the enterprise interface for performing the application and then the data generated in this application being stored in the sub-directory in the file database; furthermore, in performing the application, the application will automatically direct to the sub-directory assigned to the enterprise so that all the data needed in the application is called out from the sub-directory.

2. The cloud enterprise application system as claimed in claim 1, wherein the system has a plurality of application units and all the application units are directed to thele database; the data generated by different application unit is directed to one specific sub-directory in the file database specific to the enterprise customer using the application; moreover, for one enterprise unit, there is only one password which is acceptable by all the application units.

3. The cloud enterprise application system as claimed in claim 1, wherein the cloud server is connected to a user unit; a user is connected to the user unit for connecting the system.

4. The cloud enterprise application system as claimed in claim 2, wherein the sub-directory is stored in the user unit.

5. The cloud enterprise application system as claimed in claim 2, wherein the system management unit includes a right management unit for determining the rights of the enterprise customers for using the services.

6. The cloud enterprise application system as claimed in claim 2, wherein the system management unit includes an operation environment management unit for management of the operation environment so that the operation environment of an enterprise or a user can be stored in the cloud server; as the enterprise customer or the user changes positions to use another user unit or another user unit, he (or she) can work in the previous stored operation environment without interruption.

7. The cloud enterprise application system as claimed in claim 2, wherein the system management unit includes an encryption and decryption unit for encrypting and decrypting the data in the sub-directory so as to keep safe to the data.

8. The cloud enterprise application system as claimed in claim 2, wherein the system management unit further includes a schedule unit which can schedule a series of works to be done based on a preset work sequence.

9. The cloud enterprise application system as claimed in claim 8, wherein the schedule unit locks a file in operation to be operated by only one user.

10. The cloud enterprise application system as claimed in claim 2, wherein the enterprise unit and user unit are electronic computer devices of various forms.

11. The cloud enterprise application system as claimed in claim 1, wherein the enterprise unit and user unit are elected from one of computers, notebook computers, Ipads, and PDAs.
